(19) United States
(12) Patent Application Publication
(10) Pub. No.: US 2026/0290936 A1
(43) Pub. Date: Sep. 24, 2026

(54) BATTERY CELL STRUCTURE

(71) Applicants: Hyundai Motor Company, Seoul (KR); Kia Corporation, Seoul (KR); Valeo Kapec Co., Ltd., Daegu (KR)

(72) Inventors: Sang Wan KIM, Hwaseong-Si (KR); Jun Young LIM, Hwaseong-Si (KR); Min Yong SON, Hwaseong-Si (KR); Se Hyeon PARK, Daegu (KR); Seung Min SHIN, Daegu (KR); Ki Hong LEE, Busan (KR)

(73) Assignees: Hyundai Motor Company, Seoul (KR); Kia Corporation, Seoul (KR); Valeo Kapec Co., Ltd., Daegu (KR)

(21) Appl. No.: 19/320,319

(22) Filed: Sep. 5, 2025

(30) Foreign Application Priority Data
Mar. 24, 2025 (KR) 10-2025-0037308

(51) Int. Cl. H01M 10/6551; H01M 10/48; H01M 10/613; H01M 10/625; H01M 10/6554; H01M 10/6556; H01M 10/6567

(52) U.S. Cl. CPC H01M 10/6551; H01M 10/486; H01M 10/613; H01M 10/625; H01M 10/6554; H01M 10/6556; H01M 10/6567

(57) ABSTRACT

A battery cell structure includes a cooling fin, and a cell cartridge insert-molded to surround a portion of the cooling fin and including a battery cell disposed on any one or more of a first surface and a second surface of the cell cartridge, wherein a receiving recess is disposed at an end portion of the cell cartridge into which an end portion of the temperature sensor is inserted.

### CROSS REFERENCE TO RELATED APPLICATION

The present application claims priority to Korean Patent Application No. 10-2025-0037308, filed Mar. 24, 2025, the entire contents of which is incorporated herein for all purposes by this reference.

### BACKGROUND

### Technical Field

The present disclosure relates to a battery cell structure.

### Description of the Related Art

A battery cell is the smallest unit that stores and releases electrical energy, a battery module is an intermediate unit that electrically and mechanically connects multiple battery cells, and a battery pack is an integrated structure that ultimately completes a single or multiple battery modules.

The foregoing is intended merely to aid in the understanding of the background of the present disclosure, and is not intended to mean that the present disclosure falls within the purview of the related art which is already known to those skilled in the art.

### SUMMARY

Meanwhile, in hybrid vehicles that use both battery power and petroleum energy, a battery has a limited size. That is, when considering packaging of a vehicle in which numerous components are assembled, the size of the battery cannot be increased without limitation. Accordingly, various attempts are required to increase battery energy density, such as increasing battery capacity while maintaining battery size or maintaining battery size while maintaining battery capacity.

Additionally, in hybrid vehicles, as required power output of the vehicle gradually increases, the cooling performance of the battery mounted in the hybrid vehicle also needs to be improved. When the required power output is relatively low, sufficient cooling is possible with an air cooling method. However, with the recent trend of increasing required power output of the battery, a battery which may be cooled with a water cooling method is in demand.

The objectives of the present disclosure are not limited to those mentioned above, and other objectives not mentioned will be clearly understood by those skilled in the art from the description provided hereinafter.

To achieve the above objective, according to an aspect of the present disclosure, there is provided a battery cell structure, including: a cooling fin; and a cell cartridge insert-molded to surround a portion of the cooling fin and including a battery cell disposed on any one or more of a first surface and a second surface of the cell cartridge, wherein a receiving recess may be disposed at an end portion of the cell cartridge into which an end portion of the temperature sensor is inserted.

In an exemplary embodiment of the present disclosure, an end portion of the cooling fin corresponding to the receiving recess of the cell cartridge may be cut so that the end portion of the temperature sensor is disposed in the receiving recess.

In an exemplary embodiment of the present disclosure, the end portion of the temperature sensor may be in contact with the cell cartridge, but be spaced apart from the end portion of the cooling fin.

In an exemplary embodiment of the present disclosure, the receiving recess may be disposed on a side portion of the cell cartridge, and the temperature sensor may detect a temperature of an edge portion of the cooling fin.

In an exemplary embodiment of the present disclosure, a lower end portion of the cooling fin may be bent and in contact with a cooling plate through which a cooling medium flows.

In an exemplary embodiment of the present disclosure, the battery cell may include a sealing portion disposed so that a side portion of the battery cell is sealed by thermal fusion, and the sealing portion may include a folded portion.

In an exemplary embodiment of the present disclosure, the folded portion may be spaced apart greater than or equal to 0.3 mm from the end portion of the cell cartridge where the receiving recess is disposed.

According to the battery cell structure according to an exemplary embodiment of the present disclosure, the temperature sensor is disposed to be inserted into the cell cartridge without making surface-contact with the cooling fin, so there is no physical contact between the temperature sensor and the battery cell, and thus they do not affect each other. Additionally, since a gap is secured between the battery cell and surrounding components, even when the battery cell expands (swells), it has less impact on the surrounding components. Even when the temperature sensor is inserted into the cell cartridge, it is possible to maintain a similar sensitivity similar to that when it is brought into surface-contact with the cooling fin.

The effects of the present disclosure are not limited to those mentioned above, and other effects not mentioned will be clearly understood by those skilled in the art from the description provided hereinafter.

### BRIEF DESCRIPTION OF THE DRAWINGS

The above and other objects, features, and other advantages of the present disclosure will be more clearly understood from the following detailed description when taken in conjunction with the accompanying drawings, in which:

FIG. 1 is a view exemplarily illustrating a cooling fin forming a part of a battery cell structure according to an exemplary embodiment of the present disclosure;

FIG. 2 is a view exemplarily illustrating a battery cell structure according to an exemplary embodiment of the present disclosure;

FIG. 3 and FIG. 4 are views exemplarily illustrating a temperature sensor being inserted into a receiving recess of a cell cartridge and an end portion of the cooling fin;

FIG. 5 is a sectional view taken along line A-A of FIG. 4;

FIG. 6 is a view exemplarily illustrating a coupled state of a cooling plate and a battery pack;

FIG. 7 is a view exemplarily illustrating the cooling principle of a battery cell through the cooling plate and the cooling fin; and

FIG. 8 is a graph illustrating temperature detecting responses of the temperature sensor according to an exemplary embodiment of the present disclosure and a temperature sensor which is in surface-contact with a cooling fin.

### DETAILED DESCRIPTION

In describing embodiments disclosed in the present disclosure, when it is determined that the detailed description of the related art would obscure the gist of the present disclosure, the detailed description thereof will be omitted. Furthermore, the accompanying drawings are merely intended to be able to readily understand the exemplary embodiments disclosed herein, and thus the technical idea disclosed herein is not limited by the accompanying drawings, and it should be understood to include all changes, equivalents, and substitutions included in the idea and technical scope of the present disclosure. The following description is not intended to limit the present disclosure to the precise forms or particular fields of use disclosed. It is contemplated that various alternative embodiments and modifications to the present disclosure are possible, whether explicitly set forth or implied herein. A person of ordinary skill in the art will recognize that changes may be made in form and detail without departing from the scope of the present disclosure.

The present disclosure is described with reference to specific embodiments. However, as will be appreciated by one skilled in the art to which the present disclosure pertains, various embodiments included herein may be modified or otherwise implemented in various other ways without departing from the spirit and scope of the present disclosure. Accordingly, the following description is to be considered illustrative and is for teaching those skilled in the art the manner of making and using various embodiments. It is to be understood that the forms of disclosure herein shown and described are to be taken as representative embodiments. Equivalent elements, materials, processes or steps may be substituted for those representatively illustrated and described herein. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Additionally, reference to the singular is also to be construed to relate to the plural.

Furthermore, various embodiments included herein are to be taken in the illustrative and explanatory sense, and should in no way be construed as limiting of the present disclosure. All joining references (e.g., attached, affixed, coupled, connected, and the like) are only used to aid the reader's understanding of the present disclosure, and may not create limitations, particularly as to the position, orientation, or use of the elements and/or methods included herein. Therefore, joining references, if any, are to be construed broadly. Moreover, such joining references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation, and/or modification. That is, these expressions can be used to describe various elements, but the elements are not limited by these expressions. These expressions are only used to distinguish one element from another element.

The suffixes “module” and “part” used in the following description are given or mixed together only considering the ease of generating the specification, and have no meanings or roles that are distinguished from each other by themselves.

It will be understood that when an element is referred to as being “coupled” or “connected” to another element, it may be directly coupled or connected to the other element or intervening elements may be present therebetween. In contrast, it will be understood that when an element is referred to as being “directly coupled” or “directly connected” to another element, there are no intervening elements present.

Any number or variety of components in any of the configurations described herein may be included within the disclosure described herein. The components may include any combination of the features described herein and may be arranged in any of the various configurations described herein. The concepts regarding the structure and arrangement of the components of the present disclosure, as well as their use and operation, may be applied not only to the specific embodiments discussed herein, but to any number of embodiments in any combination. Embodiments including those having various features in various arrangements are described below with reference to the drawings.

Hereinafter, various embodiments included in the present disclosure will be described in detail with reference to the accompanying drawings, in which identical or similar elements are given the same reference numerals regardless of the reference numerals of the drawings, and repeated description thereof will be omitted.

Recently, required power output of batteries has been increasing due to the demand for improved performance of hybrid vehicles. This leads to an increase in heat generation from the hybrid vehicle battery. To address this, a water-cooling type battery cooling method is being considered because an air cooling method has limited heat dissipation efficiency.

When implementing a water-cooling type battery cooling system, a design that minimizes the height of a battery system by placing a battery at the bottom portion of a vehicle is required.

Meanwhile, overheating of the battery can cause thermal runaway and fire, so it is very important to detect the battery temperature and detect abnormal battery cells early to prevent battery abnormalities.

For the present purpose, the battery includes a temperature sensor to measure the battery temperature. The temperature sensor directly or indirectly measures the temperature of an individual battery cell or multiple battery cells and transmits it to a battery managing system (BMS) via wires, etc. The BMS detects abnormal battery cells based on measurement data and is configured to perform various controls, such as controlling abnormal battery cells to prevent them from operating.

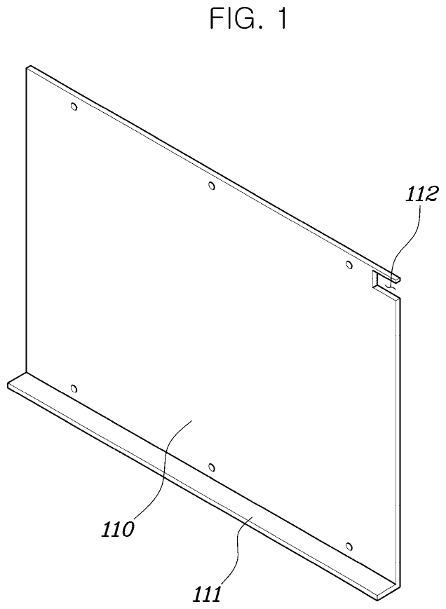

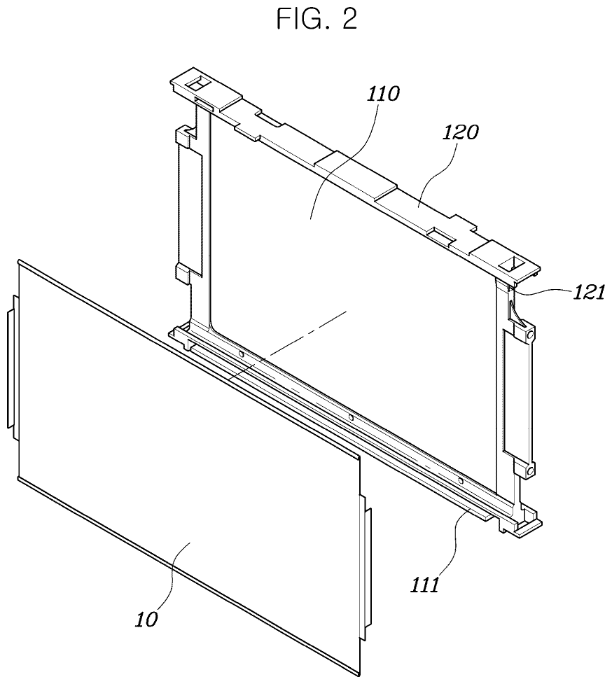

Meanwhile, the present disclosure relates to an arrangement structure of a temperature sensor configured for measuring the temperature of a battery cell. First, referring to FIGS. 1 and 2, a battery cell 10 is disposed on a first surface or a second surface of a cell cartridge 120 including a cooling fin 110. The cooling fin 110 is a configuration for cooling the battery cell 10 and is made of a metal material. In particular, it is preferable that the cooling fin 110 is manufactured from a metal having excellent thermal conductivity, such as aluminum (Al) or copper (Cu), or an alloy material including other metals.

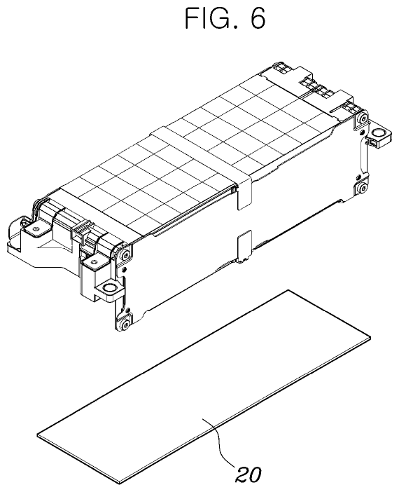

Meanwhile, referring to FIG. 6, a cooling plate 20 is provided to cool a plurality of battery cells 10 so that the plurality of battery cells 10 are cooled by a water cooling method. Referring to FIG. 1, a lower end portion of the cooling fin 110 is bent to form a bent end portion 111, and the bent end portion 111 is in contact with the cooling plate 20. A cooling medium flows inside the cooling plate 20. The battery cell 10 dissipates heat through the cooling fin 110, and the cooling fin 110 then dissipates heat to the cooling medium of the cooling plate 20 to cool the plurality of battery cells 10.

In an exemplary embodiment of the present disclosure, the cooling plate 20 includes a passage through which the cooling medium of the cooling plate 20 flows.

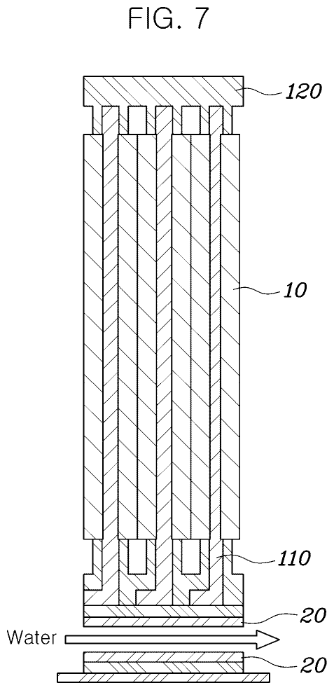

Referring to FIG. 7, it may be seen that the bent end portion 111 of the cooling fin 110 is in contact with the cooling plate 20, and the heat generated from the battery cell 10 is dissipated to the cooling medium in the cooling plate 20 through the cooling fin 110.

Meanwhile, since the cooling fin 110 itself does not include a structure for fixing the battery cell 10, a separate configuration for fixing the battery cell 10 is required. Accordingly, a cell cartridge 120 is introduced as a configuration for fixing the battery cell 10. The cell cartridge 120 fixes the battery cell 10. Also, since it is common for the plurality of battery cells 10 to be stacked, the cell cartridge 120 maintains a cell spacing between the battery cells 10, and is responsible for aligning the battery cells 10. Since the cell cartridge 120 is in close contact with the battery cell 10, the cell cartridge 120 is preferably made of an insulating material. The cell cartridge 120 may be made of a plastic material with insulating properties.

According to an exemplary embodiment of the present disclosure, the cooling fin 110 may be placed in a mold, and an insulating plastic may be injection-molded to integrate the cooling fin 110 and the cell cartridge 120. When the battery cell 10 is placed on each of a first surface and a second surface of the cell cartridge 120 in which the cooling fin 110 and the cell cartridge 120 are integrated, a single battery cell structure illustrated in FIG. 2 is completed.

Meanwhile, to directly or indirectly measure the temperature of the battery cell 10, a temperature sensor 200 may be disposed in contact with a surface of the cooling fin 110. However, when the temperature sensor 200 is disposed on the surface of the cooling fin 110, an overlapping structure such as a cooling fin-temperature sensor-battery cell structure is disposed. In the case where the temperature sensor 200 is disposed on the surface of the cooling fin 110, as in the cooling fin-temperature sensor-battery cell structure, a gap with the battery cell 10 is too narrow. Therefore, there is a concern that the battery cell 10 may come into contact with the temperature sensor 200 due to a swelling phenomenon, and the temperature sensor 200 may shake along with vehicle's driving vibrations, causing physical influence on the battery cell 10.

As a solution to these shortcomings, a method of increasing the gap between the temperature sensor 200 and the battery cell 10 may be considered, but the present method may decrease energy density.

To overcome the above-described problem, the present disclosure proposes a structure in which the temperature sensor 200 is inserted into the interior of the cell cartridge 120. A receiving recess 121 for allowing the temperature sensor 200 to be inserted therein is disposed at an end portion of the cell cartridge 120, and an end portion of the temperature sensor 200 is inserted into the receiving recess 121.

With the present structure, it is possible to cope with the swelling phenomenon of the battery cell 10. That is, even when the battery cell 10 expands, the battery cell 10 may be prevented from coming into direct contact with the temperature sensor 200, preventing physical damage to the temperature sensor 200 and the battery cell 10.

Additionally, durability of the temperature sensor 200 against vehicle's driving vibrations may be improved. That is, since the temperature sensor 200 is fixed inside the cell cartridge 120, the temperature sensor 200 may be minimized from shaking due to its own vibration, and its physical influence on the battery cell 10 can also be eliminated.

Additionally, the temperature sensor 200 may be stably maintained in its position while being inserted into the receiving recess 121 of the cell cartridge 120.

Moreover, it is possible to secure a minimum gap or more between the battery cell 10 and the temperature sensor 200, securing a free space for swelling of the battery cell 10.

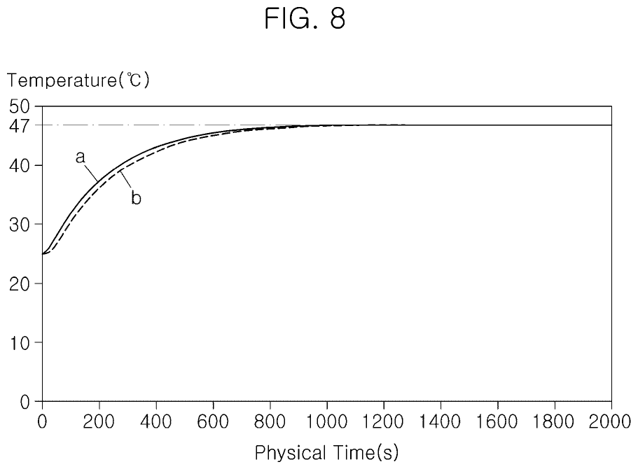

Referring to FIG. 8, as a result of analyzing detecting speeds at a temperature detecting response (a) when a temperature sensor is in surface-contact with a side surface of a cooling fin and a temperature detecting response (b) when a temperature sensor is inserted into a cell cartridge, it may be shown that a similar response speed is observed even in an initial unsteady state. This thus indicates that even when the temperature sensor 200 is inserted into the cell cartridge 120, an accurate temperature detecting function may be performed.

Meanwhile, a recess 112 may be disposed at an end portion of the cooling fin 110 by cutting the end portion of the cooling fin 110 corresponding to the receiving recess 121 of the cell cartridge 120 or through casting manufacturing of the cooling fin 110 so that the temperature sensor 200 is accommodated by the cell cartridge 120 and the recess 112.

Referring to FIG. 1, an end portion of an upper side portion of the cooling fin 110 may be cut so that the end portion of the temperature sensor 200 inserted into the receiving recess 121 of the cell cartridge 120 is surrounded by the cooling fin 110. The present enables accurate temperature detecting to be performed even when the temperature sensor 200 is not in surface-contact with the cooling fin 110.

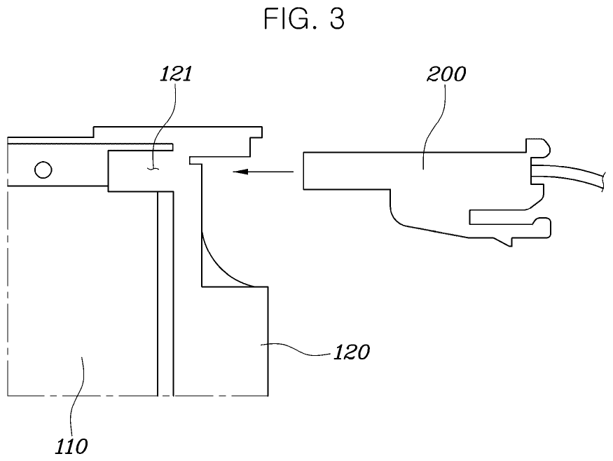

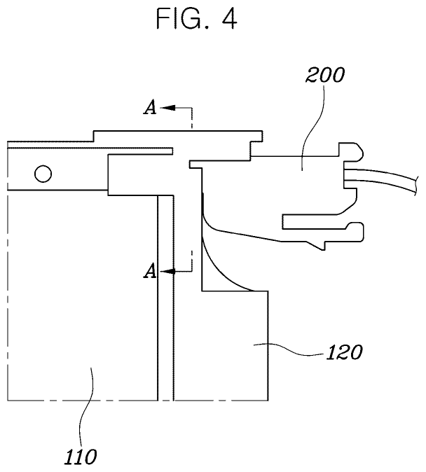

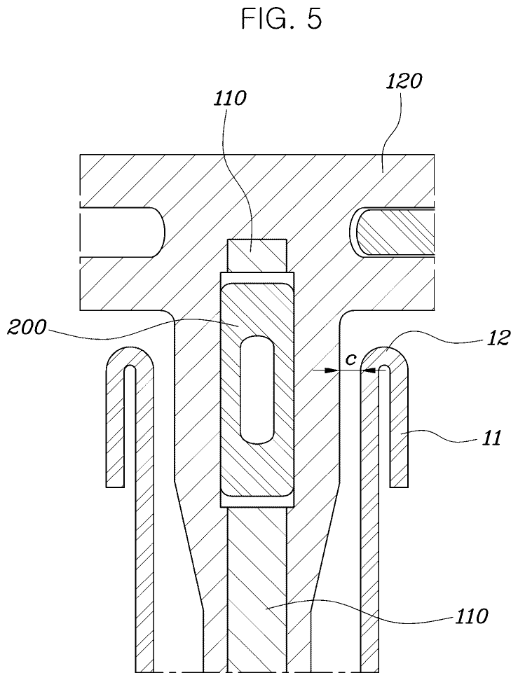

FIGS. 3 and 4 are views exemplarily illustrating the temperature sensor 200 being inserted into the receiving recess 121 of the cell cartridge 120 and the end portion of the cooling fin 110. FIG. 5 is a sectional view taken along line A-A of FIG. 4. Referring to FIGS. 3 to 5, the temperature sensor 200 is inserted into the end portion of the cell cartridge 120 and the end portion of the cooling fin 110. The temperature sensor 200 is closely in surface-contact with the periphery of the receiving recess 121 of the cell cartridge 120, while it is not in direct surface-contact with the end portion of the cooling fin 110, but is spaced apart therefrom. The receiving recess 121 of the cell cartridge 120 is disposed on a side portion of the cell cartridge 120, and the temperature sensor 200 is inserted into the receiving recess 121 of the cell cartridge 120 to detect the temperature of the edge portion of the cooling fin 110. Even when the temperature sensor 200 is not in surface-contact with the cooling fin 110, the temperature sensor 200 may reflect the temperature of the cooling fin 110 because the cooling fin 110 is made of a material with high thermal conductivity.

Meanwhile, the battery cell 10 includes a sealing portion 11 disposed so that a side portion of the battery cell 10 is sealed by thermal fusion. The battery cell 10 according to an exemplary embodiment of the present disclosure may be manufactured in a pouch type. After sequentially arranging a negative electrode, a separator, and a positive electrode in a pouch, the edge portions of the pouch may be thermally fused to seal the pouch. Additionally, the sealing portion 11 may be folded to form a folded portion 12 so that the plurality of battery cells 10 are aligned at a uniform height.

According to an exemplary embodiment of the present disclosure, the folded portion 12 may be spaced apart at least 0.3 mm from the end portion of the cell cartridge 120 where the receiving recess 121 is disposed. In the case where the temperature sensor 200 is brought into surface-contact with the cooling fin 110, the size of a battery module and a battery pack is inevitably increased to form a separation distance between the temperature sensor 200 and the folded portion 12 of the battery cell 10 to be greater than or equal to 0.3 mm. However, according to an exemplary embodiment of the present disclosure in which the temperature sensor 200 is inserted into the cell cartridge 120, it is possible to easily secure a separation distance c of greater than or equal to 0.3 mm between the battery cell 10 and the cell cartridge 120, enabling coping with the swelling phenomenon of the battery cell 10 and minimizing the influence of interference between the battery cell 10 and other components. Additionally, there is an advantage in that it is easier to increase the energy density of the battery than when the temperature sensor 200 is brought into surface-contact with the cooling fin 110.

Although specific embodiments of the present disclosure have been described for illustrative purposes, those skilled in the art will appreciate that various modifications, additions, and substitutions are possible, without departing from the scope and spirit of the present disclosure as disclosed in the appended claims.

What is claimed is:

1. A battery cell structure, comprising:
a cooling fin;
a cell cartridge insert-molded to surround a portion of the cooling fin and including a battery cell disposed on one or both of a first surface and a second surface of the cell cartridge; and
a receiving recess disposed at an end portion of the cell cartridge into which an end portion of a temperature sensor is inserted.

2. The battery cell structure of claim 1, wherein an end portion of the cooling fin corresponding to the receiving recess of the cell cartridge is shaped to allow the end portion of the temperature sensor to be disposed in the receiving recess.

3. The battery cell structure of claim 2, wherein the end portion of the temperature sensor is in contact with the cell cartridge and is spaced apart from the end portion of the cooling fin.

4. The battery cell structure of claim 1,
wherein the receiving recess is disposed on a side portion of the cell cartridge, and
wherein the temperature sensor detects a temperature of an edge portion of the cooling fin.

5. The battery cell structure of claim 1, further including a cooling plate,
wherein a lower end portion of the cooling fin is in contact with the cooling plate through which a cooling medium flows.

6. The battery cell structure of claim 5,
wherein the lower end portion of the cooling fin is bent in “L” shape and a bottom portion of the lower end portion of the cooling fin is in contact with the cooling plate.

7. The battery cell structure of claim 5, wherein the cooling plate includes a passage through which the cooling medium flows.

8. The battery cell structure of claim 1,
wherein the battery cell includes a sealing portion disposed so that a side portion of the battery cell is sealed by thermal fusion.

9. The battery cell structure of claim 8,
wherein the battery cell further includes a folded portion bent from the sealing portion.

10. The battery cell structure of claim 8, wherein the folded portion is spaced apart by a predetermined distance from the end portion of the cell cartridge where the receiving recess is disposed.

11. The battery cell structure of claim 10, wherein the predetermined distance is greater than or equal to 0.3 mm.

12. A vehicle comprising the battery cell structure of claim 1.
